(19) United States
(12) Patent Application Publication
(10) Pub. No.: US 2020/0236880 A1
(43) Pub. Date: Jul. 30, 2020

(54) SELF-WATERING CONTAINER

(71) Applicant: Kionna Harris Wells, Hazelwood, MO (US)

(72) Inventor: Kionna Harris Wells, Hazelwood, MO (US)

(21) Appl. No.: 16/257,558

(22) Filed: Jan. 25, 2019

(51) Int. Cl. A01G 27/00; A01G 9/02

(52) U.S. Cl. CPC A01G 27/005; A01G 9/021; A01G 27/008

(57) ABSTRACT

A self-watering planter of unitary construction amendable to additive manufacture is provided. A divider divides an upper space of the planter for soil and a lower space for a water reservoir, wherein a conduit extends from the reservoir through the divider to an open end of the upper space, wherein the reservoir can be filled through the conduit. The divider provides a planar first portion and a tubular second portion that depend therefrom into the reservoir. A soil opening in the first portion communicates soil in the upper space with soil compacted in the second portion. A drain hole near an upper portion of the reservoir results in all water from the reservoir to pass through saturation holes in the second portion into the compacted soil therein for leaching into the soil of the upper spaced.

### BACKGROUND OF THE INVENTION

The present invention relates to self-watering planters and, more particularly, to a single-component self-watering planter embodying a closed loop reservoir system, whereby the self-watering planter is amenable to an additive manufacture method of manufacturing.

Most people who want to grow plants as a hobby have a hard time maintaining an adequate and sustainable watering schedule for their growing pots or containers. The problem with conventional flower pots or planters is that they require daily and/or weekly watering maintenance schedules, while most consumers' busy schedules do not allow for such necessary time and commitment to care for living plants.

Current “self-watering” containers use a third component in the form of a tubed wicker or fabric wicker, and/or use multiple moving mechanical parts, all of which demand high maintenance. Furthermore, conventional self-watering systems also require electricity or another external means for supplying an adequate water source, which also needs to be maintained, as well as adds to the overall cost of these solutions. Finally, because of the inherent requirement for additional components and/or external means, and the attendant costs, today's self-watering containers offer minimum choices in terms personalization or size selection.

As can be seen, there is a need for a self-watering planter embodying a closed loop reservoir system that has zero moving parts, no physical wicker component so that consumers can conveniently grow and maintain their flowers, fruit, vegetables, and other organics with minimal commitment. Furthermore, the closed loop reservoir system of the present invention enables a single-component self-watering planter—capable of being made via 3D printing, laser sintering technology, or the like. Thereby allowing for the creation of customizable, variable-sized planters and containers for the home, office, urban patio and garden. The present invention does not require watering for up to 30 days, while still facilitating flowers, fruit, vegetables, and other organics to grow during that time period through use of gravity to filter water through the soil, maximizing the use of the already existing and readily available soil to supply the growing plant with nutrients. The present invention may also use a corrugated tubing methodology for strength capabilities.

### SUMMARY OF THE INVENTION

In one aspect of the present invention, a self-watering planter of unitary construction includes the following components: an outer shell defining a cavity; a divider dividing the cavity between an upper space and a lower space; the divider providing: a planar first portion extending in a horizontal orientation, the first portion having a soil opening; a tubular second portion transversely depending from the first portion into the lower space, the tubular second portion communicating with the soil opening; and a plurality of spaced apart saturation holes spaced apart along the divider; a drain hole in the outer shell just downward of the first portion; and a conduit extending from near an open end, through the first portion, and into the lower space. In another aspect of the present invention, the self-watering planter of unitary construction further includes a soil core defined by the soil opening and the second portion, and wherein a reservoir defined by the outer shell, the first portion and the second portion; and a plurality of spaced apart saturation holes spaced apart along the divider, wherein the saturation holes, based on a 4 inch tall basic square design, are spaced equally across a 3.5 inch×3.5 inch divider. The holes are approximately ⅛-inch in diameter, ½ inch from center to center, and are equally spaced across the divider. The soil core may be placed in the center of the divider and may be ½ inch in diameter. The soil core may be 1½ inch tall and may be the same depth of the reservoir. There may be four or more support structures (approximately 1 inch in diameter) and extending between the divider and the lower portion of the outer shell to support the former. The reservoir may be 1½ inch tall by 3½ inch by 3½ inch wide, based on a 4-inch tall basic square design. The size of the container is scalable and is limited in size only by the method of manufacturing. In another aspect of the present invention, a method of growing a plant in a self-watering planter so that the plant need not be watered more than once every 30 days including the following components: designing the above-mentioned self-watering planter so that the reservoir is dimensioned to provide sufficient volume for holding water; filling the upper space with soil; compactly, relative to the upper space, filling the soil core with soil; planting the plant in the soil of the upper space; and pouring water in an upper portion of the conduit until water flows through the drain hole.

The soil media is very important with container growing. The soil media should be well aerated and drained, while retaining enough moisture for organic growth. Container soil can also be soilless, house artificial media, or have no soil at all. Depending on the plant, the soil media can be composed of various soil medias; such as peat, vermiculite, bark, coir fiber, ground coconut hulls, and/or, a variety of mixtures, depending on the manufacture and the type of plant growing. The choice of media will be directed by what type of organic growing. Succulents, herbs, and perennials tend to prefer soils that are well drained. They do not retain a lot of moisture over a long period of time. The soil media may be courser in texture containing more material such as bark, perlite or sand.

The soil media for topicals and foliage plants, may require more peat and less course material as these plants tend to prefer more moisture and wetter growing conditions.

The soil media can be modified or amended based on achieving an acceptable soil mixture, that can be made one-part garden soil, one-part peat moss, and one-part perlite or coarse builders' sand.

A sheet of thin barrier material, may be made from unbleached 100 g/m2 filter paper, and may be placed between the soil media and the rest of the container. The material keeps the soil media from infiltrating the reservoir, while allowing water to drain and pass through. The components allow for aeration and space for roots to grow.

In another aspect of the present invention, a method of manufacturing a self-watering planter of unitary construction so that sizes and shapes are customizable, includes the following creating a solid model of the above-mentioned self-watering planter of; and growing layer by layer through additive manufacturer the divider, the conduit, the drain hole of said self-watering planter as the outer shell thereof is built up.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention, shown in use;

FIG. 2 is a front perspective view of an exemplary embodiment of the present invention;

FIG. 3 is a rear perspective view of an exemplary embodiment of the present invention;

FIG. 4 is a section view of an exemplary embodiment of the present invention, taken along line 4-4 of FIG. 2;

FIG. 5 is a cut away perspective view of an exemplary embodiment of the present invention, demonstrating an operative effect; and

FIG. 6 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a self-watering planter of unitary construction amendable to additive manufacture, and so making such planters conveniently customizable in terms of size and shape. A divider divides an upper space of the planter for soil and a lower space for a water reservoir, wherein a conduit extends from the reservoir through the divider to an open end of the upper space, wherein the reservoir can be filled through the conduit. The divider provides a planar first portion and a tubular second portion that depend therefrom into the reservoir. A soil opening in the first portion communicates soil in the upper space with soil compacted in the second portion. A drain hole near an upper portion of the reservoir causes all water from the reservoir to pass through saturation holes in the second portion into the compacted soil therein for leaching into the soil of the upper spaced. Thereby, this closed loop reservoir system enables one watering of the reservoir to provide sufficient water of the soil of the upper space for 30 days.

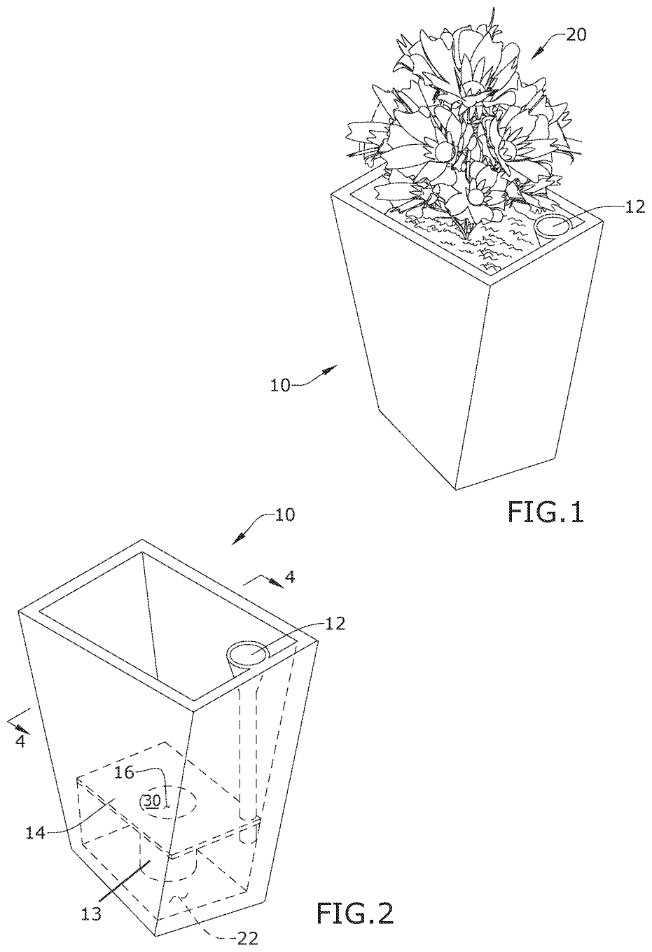

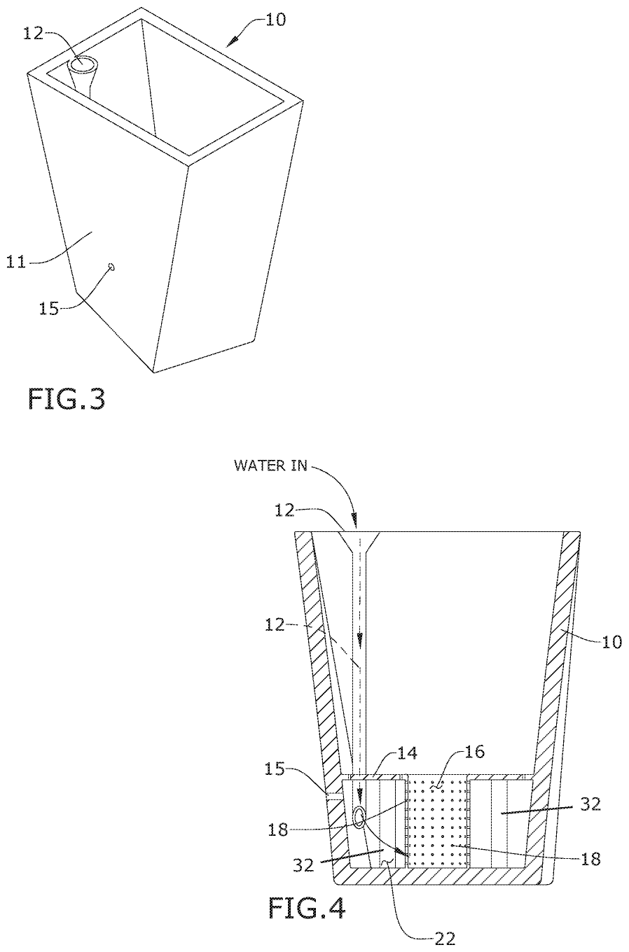

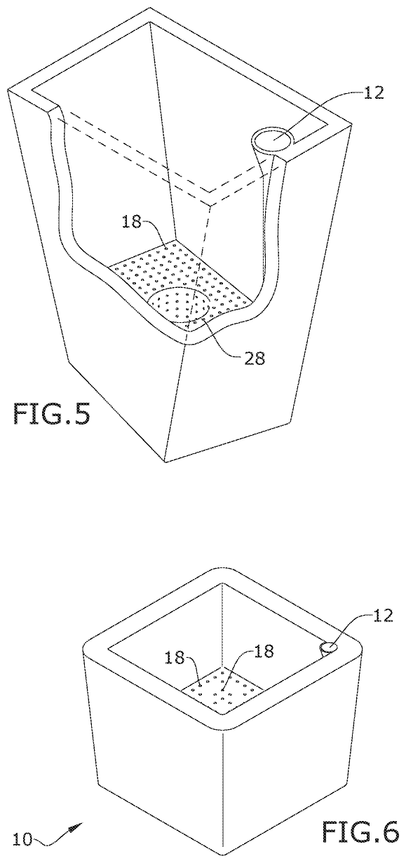

Referring to FIGS. 1 through 6, the present invention may include a self-watering planter 10 embodying a closed loop reservoir system that has zero moving parts, wherein the self-watering planter 10 is a unitary construction capable of being made with additive manufacturer.

The self-watering planter 10 provides an outer shell 11 dimensioned to define a cavity to accommodate sufficient soil and water for a variety of different plant life 20. The outer shell 11 extends from a closed lower end to an open upper end. It should be understood by those skilled in the art that the use of directional terms such as lower, bottom, upper, top, and the like are used in relation to the illustrative embodiments as they are depicted in the figures. For example, the upward (upper) direction being toward the top of the corresponding figures and a downward (lower) direction being toward the bottom of the corresponding figure.

A divider 14, as illustrated in FIG. 4, divides the cavity between a lower space and an upper space. The divider 14 provides a planar first portion 28 and one ore more tubular second portions 13 depending therefrom. One of the second portions 13 may be centrally disposed along the first portion 28 as said second portion 13 extends into the lower space. It is to be understood that although the Figures show only one second portion 13 for the sake of clarity, there are embodiments that include more than one second portions 13, some communicating with a soil opening 30 communicating with the upper space and others possibly that are closed off on an upper end by the first portion 18, whereby these latter second portions 13 are more for structural support.

The first and second portions 28 and 13 have spaced apart saturation holes 18 there along, whereby the saturation holes 18 fluidly communicating the lower and upper spaces. The saturation holes 18 may be ⅛-inch diameter holes equally spaced across a 3.5-inch×3.5-inch surface, ½ inch from center to center, covering the entire surface area of the divider 14, including first portion 28 and the second portion(s) 28. The ⅛-inch holes continue with the same matrix into and including the soil core 16.

The divider 14 may be horizontally oriented relative to any supporting surface the lower end would be supported on. The first portion 28 may be adapted to support soil contained within the upper space. Soil could also fill (through the above-mentioned soil opening 30) and occupy the space defined by one or more of the second portions 13, such second portion space 16 is also known as a soil core 16. The remaining space of the lower space not occupied by a second portion and/or soil core 16, may be filled by a fluid, such as water and will be referenced as the reservoir 22 hereafter. Note the spaced apart saturation holes 18 along each tubular second portion 13 fluidly connects the reservoir 22 with the relevant soil core 16.

A conduit 12 may extend from the reservoir 22 through the first portion 28 to near, at, or adjacent to the open upper end by less than ¼ inch. The circumference of the conduit 12 may be proportionate to the outer shell 11 size. The conduit 12 may start ½ inch from the bottom of reservoir 22. The conduit 12 may be always covered with a standard ½-inch diameter marble. The marble aids in providing a closed loop system, and prevents unwanted dirt and other organics to enter the reservoir 22.

A drain hole 15 may fluidly connect the reservoir 22 to an exterior of the outer shell 11 for draining the water, keeping the reservoir 22 from overflowing. The drain hole 15 may be ¼-½ inch in diameter. The drain hole 15 also creates an air gap in between the divider 14 and the reservoir 22, and so water in the reservoir 22 may only migrate to the soil of the upper space through the soil in the soil core 16.

The divider 14 is adapted to be a drain layer between the upper space (containing soil) and the lower space (containing water), whereby any excess water from the soil may flow back to the reservoir. Each tubular second portion 13 may be adapted to be a column that holds of the first portion 28 and any soil thereon that it supports. Each tubular second portion 13 may be manufactured using a corrugated tubing method. Note, in the embodiment with a plurality of tubular second portions 13, only one may communicate to the upper space through the soil opening 30 in the first portion 28 for allowing soil to continuously fill the soil core space 16 of that second portion 13 and the soil of the upper space. Soil in the soil core space 16 tends to be compacted to a greater extent or to a more particularity 35% less dense relative to the soil in the upper space.

Support posts 32 may assist in supporting the structural weight of the soil media and plant. The supports may be 1-inch diameter and extend the depth of the reservoir 22 supporting the divider 14 on a lower portion of the outer shell 11.

Because of the unitary construction of the self-watering planter 10, 3D software may be utilized to create a solid model without the use of rapid prototyping. The solid model may be sent to a stereolithography (SLS) or laser sintering file and manufactured using 3-D printing or rapid prototyping. The components and parts will be “grown” using 3D printing or stereolithography (SLS) technology. The present invention and all items will be fabricated all as one single piece, layer by layer: the divider 14, the conduit 12, the drain hole 15 may be built up as the outer shell 11 is additively manufactured. For the purpose of manufacturability, the saturation holes 18 may be tear drop shaped instead of complete circles.

A method of using the present invention may include the following. The self-watering planter 10 disclosed above may be provided. A user would fill the upper space with soil and relatively more compacted soil in the soil core 16. Then the user may provide water through the upper end of the conduit 12 filling up the reservoir 22, whereby excess water will flow through the drain hole 15 in the reservoir 22. With the reservoir 22 dimensioned to provide water to the soil of the upper space through the saturation holes 18 of the soil core 16 only, the user need only water the reservoir 22 one time every 30 days or more. Specifically, soil that occupies the soil core 16 is fluidly coupled to the reservoir 22 through the vertical oriented saturation holes 18. The soil of the soil core 16 is the point of moisture contact for the remaining soil of the upper space—allowing for water to filter throughout the system and keep the roots of the plant life 20 properly watered of a 30-day timeline with just one filling of the reservoir 22.

Most consumer have a hard time maintaining an adequate and sustainable watering schedule for their growing pots or containers. The extended water scheduling time enabled by the present invention will allow the user more leisure time by lessening the watering cycle schedule, as well as take the worry out of forgetting to water their flowers, fruit, vegetables, and other organics.

Additionally, the present invention can be used in any field that requires draining or proper draining while growing or maintain adequate water supply. The present invention can be used in a large scale outside growing area where gardening may be difficult due to an adequate water supply.

It should be understood, of course, that the foregoing relates to exemplary embodiments of the invention and that modifications may be made without departing from the spirit and scope of the invention as set forth in the following claims.

What is claimed is:

1. A self-watering planter of unitary construction, comprising:
an outer shell defining a cavity;
a divider dividing the cavity between an upper space and a lower space;
the divider comprising:
a planar first portion extending in a horizontal orientation, the first portion having a soil opening;
a tubular second portion transversely depending from the first portion into the lower space, the tubular second portion communicating with the soil opening; and
a plurality of spaced apart saturation holes spaced apart along the divider;
a drain hole in the outer shell just downward of the first portion; and
a conduit extending from near an open end, through the first portion, and into the lower space.

2. The self-watering planter of unitary construction of claim 1, wherein a reservoir defined by the outer shell, the first portion and the second portion.

3. The self-watering planter of unitary construction of claim 1, wherein a soil core is defined by the soil opening and the second portion.

4. The self-watering planter of unitary construction of claim 1, wherein the saturation holes are approximately ⅛-inch in diameter.

5. The self-watering planter of unitary construction of claim 3, wherein a first soil substantially occupies the upper space and a second soil occupies the soil core, wherein the second soil is substantially 35% less densely packed than the first soil.

6. A self-watering planter of unitary construction, comprising:
an outer shell defining a cavity;
a divider dividing the cavity between an upper space and a lower space;
the divider comprising:
a planar first portion extending in a horizontal orientation, the first portion having a soil opening;
a tubular second portion transversely depending from the first portion into the lower space, the tubular second portion communicating with the soil opening, wherein a soil core is defined by the soil opening and the second portion, and wherein a reservoir defined by the outer shell, the first portion and the second portion; and
a plurality of spaced apart saturation holes spaced apart along the divider, wherein the saturation holes are approximately ⅛-inch diameter holes;
a drain hole in the outer shell just downward of the first portion;
a conduit extending from near an open end, through the first portion, and into the lower space; and
a plurality of support posts extending between the divider and a lower portion of the outer shell.

7. The self-watering planter of unitary construction of claim 6, wherein a first soil substantially occupies the upper space and a second soil occupies the soil core, wherein the second soil is 35%, with a plus or minus 10% variation, depending on the organic, less densely packed.

8. A method of growing a plant in a self-watering planter so that the plant need not be watered more than once every 30 days, comprising:
designing the self-watering planter of claim 5 so that the reservoir is dimensioned to provide sufficient volume for holding water;
filling the upper space with soil;
compactly, relative to the upper space, filling the soil core with soil;
planting the plant in the soil of the upper space; and
pouring water in an upper portion of the conduit until water flows through the drain hole.

9. A method of manufacturing a self-watering planter of unitary construction so that sizes and shapes are customizable, comprising:
creating a solid model of the self-watering planter of claim 1; and
growing layer by layer, through additive manufacturer the divider, the conduit and the drain hole of said self-watering planter as the outer shell thereof is built up.
